(19) United States
(12) Patent Application Publication
(10) Pub. No.: US 2019/0061113 A1
(43) Pub. Date: Feb. 28, 2019

(54) UNIVERSALLY ADAPTABLE FASTENING TOOL

(71) Applicants: Fu Tai Hua Industry (Shenzhen) Co., Ltd., Shenzhen (CN); HON HAI PRECISION INDUSTRY CO., LTD., New Taipei (TW)

(72) Inventors: SHUN-CHUAN YANG, New Taipei (TW); YANG ZHAO, Shenzhen (CN)

(21) Appl. No.: 15/859,748

(22) Filed: Jan. 2, 2018

(30) Foreign Application Priority Data
Aug. 31, 2017 (CN) 201721110812.7

(51) Int. Cl. B25B 13/50; B25B 23/00

(52) U.S. Cl. CPC B25B 13/50; B25B 23/0007

(57) ABSTRACT

A fastening tool able to fasten different types of fastener includes a main body and a sliding assembly. The main body defines a receiving space. The sliding assembly is slidably arranged in the receiving space. The receiving space forms an internal corner used as a clamping groove. An end of the sliding assembly defines a latching groove and the clamping groove faces the latching groove. When the sliding assembly is driven to slide in the receiving space, a clamping size to match the head of a fastener is achieved, the clamping being with a great force and with precision of contact on the plan view profile of the fastener.

### CROSS-REFERENCE TO RELATED APPLICATIONS

This application claims priority to Chinese Patent Application No. 201721110812.7 filed on Aug. 31, 2017, the contents of which are incorporated by reference herein.

### FIELD

The subject matter herein generally relates to mechanical tools, and particularly to a universally adaptable fastening tool.

### BACKGROUND

Many mechanical components, such as screws and nuts, are fastened by a fastening tool, such as a wrench. However, a shape and a size of the mechanical component are usually are complex and various, a common wrench cannot adapt to the mechanical components of different types.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view illustrating an exemplary embodiment of a fastening tool.

FIG. 2 is an exploded view illustrating an exemplary embodiment of the fastening tool in FIG. 1.

FIG. 3 is a cross section view of the fastening tool along a line in FIG. 1.

FIG. 4 illustrates the fastening tool clamping a fastenable component.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” exemplary embodiment in this disclosure are not necessarily to the same exemplary embodiment, and such references mean “at least one”.

The term “comprising” means “including, but not necessarily limited to”, it specifically indicates open-ended inclusion or membership in a so-described combination, group, series, and the like.

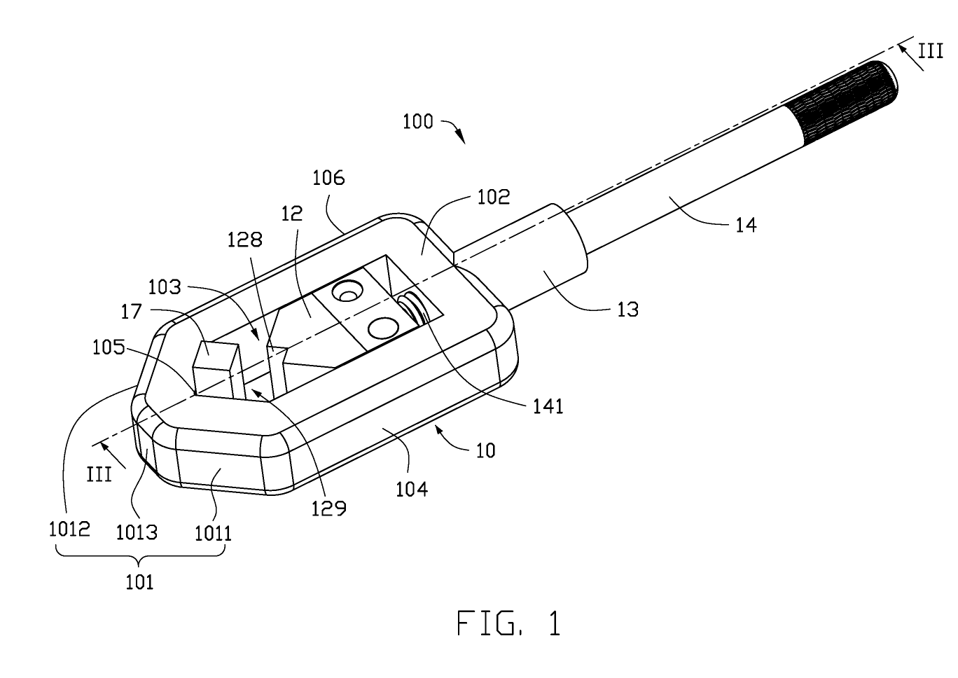

FIG. 1 illustrates an exemplary embodiment of a fastening tool 100. The fastening tool 100 includes a main body 10, a sliding assembly 12, and a driving element 14.

In at least one exemplary embodiment, the main body 10 is a polyhedron. The main body 10 includes a first end 101, a second end 102, a first sidewall 104, and a second sidewall 106. The first end 101 faces the second end 102, the first sidewall 104 faces away from the second sidewall 106. The main body 10 further defines a receiving space 103. The receiving space 103 is formed by encircling of the first end 101, the second end 102, the first sidewall 104, and the second sidewall 106. The receiving space 103 is used for receiving the sliding assembly 12.

A cross-section of the first end 101 is triangular, the first end 101 includes a first surface 1011, a second surface 1012, and a third surface 1013. The third surface 1013 is arranged between the first surface 1011 and the second surface 1012. An angle is formed between the first surface 1011 and the second surface 1012, thus a groove (clamping groove 105) is formed between the first surface 1011 and the second surface 1012. In at least one exemplary embodiment, the clamping groove 105 is substantially triangular.

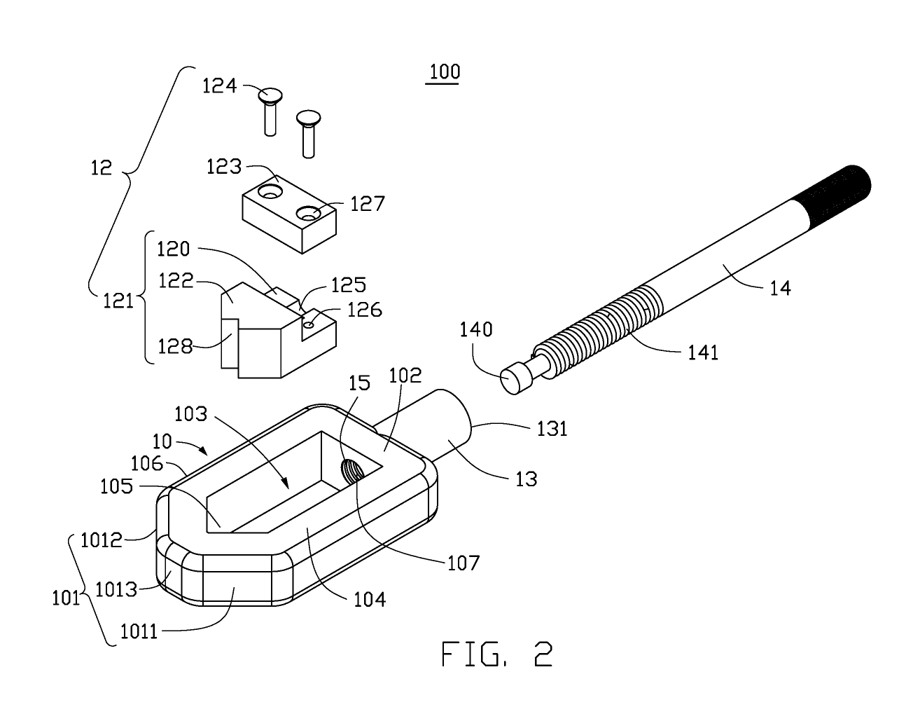

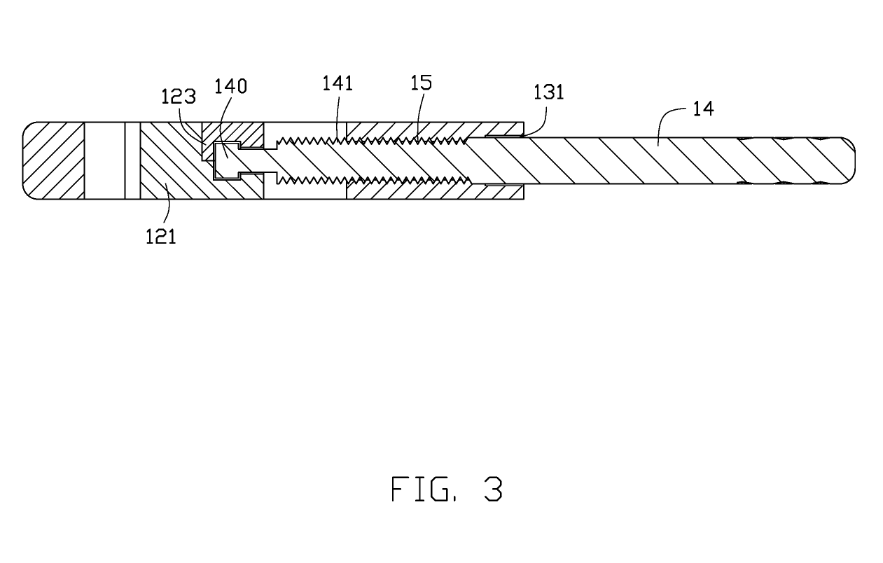

Referring to FIGS. 1-2, the main body 10 further defines a through hole 107. The through hole 107 is arranged on the second end 102 of the main body 10, and connected to the receiving space 103. The fastening tool 100 further includes a receiving member 13. The receiving member 13 is substantially a cylinder, and is formed by the second end 102 extending outward. The receiving member 13 defines an axial receiving hole 131. The receiving hole 131 passes through the receiving member 13, and connected to the through hole 107. Referring to FIG. 3, an inner wall of the through hole 107 and an inner wall of the receiving hole 131 both define a thread member 15.

The sliding assembly 12 is mounted in the receiving space 103, and can slide in the receiving space 103. The sliding assembly 12 includes a sliding block 121, a fixing block 123, and at least one fixing element 124. The sliding block 121 includes a fixing member 120 and a clamping member 122. The clamping member 122 is connected with the fixing member 120, a ladder is formed between the clamping member 122 and the fixing member 120. The fixing member 120 defines a connection groove 125, which is used for receiving an end of the driving element 14. The fixing member 120 further defines a fixing hole 126 on each of two sides of the connection groove 125.

The clamping member 122 defines a latching groove 128 away from an end of the fixing member 120. In at least one exemplary embodiment, the latching groove 128 is triangular. When the sliding block 121 is mounted in the receiving space 103, the latching groove 128 faces the clamping groove 105, thus a clamping space 129 is formed between the latching groove 128 and the clamping groove 105. When the sliding assembly 12 is driven to slide in the receiving space 103, a size of the clamping space 129 is changed, thus the clamping space 129 can adapt to components 17 to be fastened with different shapes and sizes.

As illustrated in FIG. 3, the fixing block 123 is arranged above the connection groove 125. The fixing block 123 defines a mounting hole 127. When an end of the driving element 14 is received in the connection groove 125, the fixing element 124 is mounted in the mounting hole 127 and the fixing hole 126, thus the end of the driving element 14 is latched in the connection groove 125. The driving element 14 is used for driving the sliding assembly 12 to slide in the receiving space 103, and the end of the driving element 14 can rotate relative to the sliding assembly 12 in the connection groove 125. In at least one exemplary embodiment, the fixing element 124 can be a screw, the sliding assembly 12 can include two fixing elements 124.

In at least one exemplary embodiment, the driving element 14 is a round rod. The driving element 14 includes a connection end 140. The connection end 140 passes through the receiving hole 131 and the through hole 107, then the connection end 140 is mounted in the connection groove 125 of the sliding assembly 12. At this time, the connection end 140 is latched in the connection groove 125, that is, the driving element 14 is connected with the sliding assembly 12, so that the driving element 14 can rotate relative to the sliding assembly 12.

In at least one exemplary embodiment, the driving element 14 further includes a rotation member 141. The rotation member 141 is adjacent to the connection end 140. The rotation member 141 is a thread defined on the driving element 14. When the connection end 140 passes through the receiving hole 131 and the through hole 107, the rotation member 141 can work with the thread member 15. The driving element 14 can move relative to the main body 10, and drive the sliding assembly 12 to slide in the receiving space 103.

As illustrated in FIG. 1, in at least one exemplary embodiment, when a component 17 needs to be fastened, an end away from the connection end 140 of the driving element 14 is driven to rotate. The rotation member 141 thus rotates relative to the thread member 15, and the sliding assembly 12 is driven to slide towards the second end 102 in the receiving space 103, thus the size of the clamping space 129 can be enlarged.

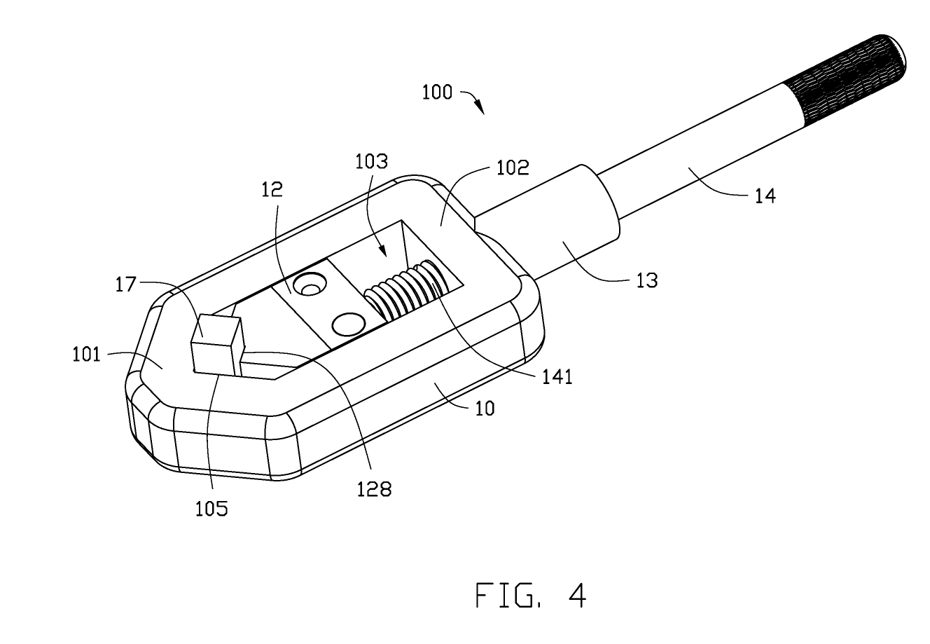

As illustrated in FIG. 4, when the component 17 to be fastened is placed in the clamping space 129, the end away from the connection end 140 of the driving element 14 is rotated inwards, the rotation member 141 rotates relative to the thread member 15. The driving element 14 moves towards the clamping groove 105 of the first end 101, until the clamping groove 105 clamps the component 17 with a substantial force and precise contact.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A fastening tool comprising:
a main body defining a receiving space; and
a sliding assembly slidably arranged in the receiving space, wherein the receiving space defines a clamping groove, an end of the sliding assembly defines a latching groove, the clamping groove faces the latching groove and defines a clamping space, when the sliding assembly is driven to slide in the receiving space, a size of the clamping space is adjusted.

2. The fastening tool according to claim 1, further comprising:
a driving element connected with the sliding assembly, wherein the driving element is used for driving the sliding assembly is driven to slide in the receiving space.

3. The fastening tool according to claim 1, wherein main body comprises a first end and a second end, the first end faces the second end, the clamping groove is arranged in a sidewall close to a first end of the receiving space, the clamping groove is triangular, and extends to the second end.

4. The fastening tool according to claim 3, wherein the main body further defines a through hole on the second end, the through hole is connected with the receiving space.

5. The fastening tool according to claim 4, further comprising:
a receiving member formed by the second end extending outwards and defining an axial receiving hole, wherein the receiving hole passes through the receiving member, and connects to the through hole.

6. The fastening tool according to claim 5, wherein an inner wall of the through hole and an inner wall of the receiving hole define a thread member.

7. The fastening tool according to claim 4, wherein the sliding assembly comprises a sliding block, the sliding block comprises a fixing member and a clamping member connected with the fixing member, the fixing member defines a connection groove and a fixing hole on each of two sides of the connection groove, the clamping member defines a latching groove away from an end of the fixing member.

8. The fastening tool according to claim 7, wherein the sliding assembly further comprises a fixing block arranged above the connection groove, and the fixing block defines a mounting hole.

9. The fastening tool according to claim 8, wherein the sliding assembly further comprises at least one fixing element, the at least one fixing element is mounted in the mounting hole and the fixing hole, and used for mounting the fixing block on the sliding block.

10. The fastening tool according to claim 9, wherein the driving element comprises a connection end, the connection end passes through the receiving hole and the through hole, then the connection end is mounted in the connection groove of the sliding assembly, so that the connection end is latched in the connection groove, the driving element rotates relative to the sliding assembly.

11. The fastening tool according to claim 10, wherein the driving element further comprises a rotation member, the rotation member is adjacent to the connection end, the rotation member is a thread defined on the driving element, when the connection end passes through the receiving hole and the through hole, the rotation member works with the thread member, the driving element moves relative to the main body, and drives the sliding assembly to slide in the receiving space.
